(19) United States
(12) Patent Application Publication
(10) Pub. No.: US 2025/0093828 A1
(43) Pub. Date: Mar. 20, 2025

(54) TRAINING A HIGH-LEVEL CONTROLLER TO GENERATE NATURAL LANGUAGE COMMANDS FOR CONTROLLING AN AGENT

(71) Applicant: DeepMind Technologies Limited, London (GB)

(72) Inventors: Arun Ahuja, London (GB); Robert David Fergus, New York, NY (US); Ishita Dasgupta, Brooklyn, NY (US); Kavya Venkata Kota Sai Kopparapu, New York, NY (US)

(21) Appl. No.: 18/892,260

(22) Filed: Sep. 20, 2024

Related U.S. Application Data
(60) Provisional application No. 63/584,156, filed on Sep. 20, 2023.

(51) Int. Cl. G05B 13/02; G06F 40/58; G06N 3/09; G06N 3/092

(52) U.S. Cl. CPC G05B 13/027; G06N 3/09; G06N 3/092; G06F 40/58

(57) ABSTRACT

Methods, systems, and apparatus, including computer programs encoded on a computer storage medium, for training a high-level controller neural network for controlling an agent. In particular, the high-level controller neural network generates natural language commands that can be provided as input to a low-level controller neural network, which generates control outputs that can be used to control the agent.

### CROSS-REFERENCE TO RELATED APPLICATION

This application claims priority to U.S. Provisional Application No. 63/584,156, filed on Sep. 20, 2023. The disclosure of the prior application is considered part of and is incorporated by reference in the disclosure of this application.

### BACKGROUND

This specification relates to controlling agents using neural networks.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls an agent that is interacting in an environment based on outputs generated by a high-level controller neural network and a low-level controller neural network. In particular, the high-level controller neural network generates natural language commands that are then processed by the low-level controller neural network in order to generate control inputs for the agent.

In general terms, the present disclosure proposes that an agent interacting with an environment (e.g., a real-world environment) is controlled by: a first “high-level” controller neural network trained to receive an input comprising an observation characterizing a state of an environment at a certain time (a “time-step”, which is one of a sequence of time-steps), and to generate, from the input, an output defining a natural language command; and a second “low-level” controller neural network which processes the natural language command to generate control outputs for controlling the agent. The high-level controller may have been trained by a method comprising: obtaining a training data set comprising a plurality of demonstration trajectories, each demonstration trajectory comprising, for each of a plurality of time steps, a respective observation characterizing a state of a demonstration environment being interacted with by a demonstration agent at the time step and a respective natural language command provided to the demonstration agent at the time step; and training the high-level controller neural network on the demonstration trajectories in the training data set through supervised learning.

Demonstration trajectories of this kind are relatively cheap to generate, such as by using humans to generate the natural language commands of the demonstration trajectories. The natural language commands may break a task which is performed in a corresponding demonstration trajectory into sub-tasks associated with corresponding ones of the natural language commands. This makes it possible to benefit from human understanding of the task. A possible result of this is that a control system employing the trained high-level controller to control a low-level controller (such as one which is trained separately) may be capable of controlling the agent to perform with a high success rate complex tasks (e.g., ones different from the task(s) performed in the corresponding demonstration trajectories), such as tasks which are best performed by performing a long sequence of sub-tasks. In other words, the high-level controller may be able to emulate the human ability to break a task the agent is desired to perform into simpler sub-tasks, and the low-level controller may be trained to perform the simpler sub-tasks, which may be easier and more successful than training it to perform the complex tasks.

Particular embodiments of the subject matter described in this specification can be implemented so as to realize one or more of the following advantages.

Despite several recent successes of reinforcement learning (RL), a major challenge has been using neural networks trained through RL to control agents in real world settings. For example, goal-directed behavior over long time horizons has thus far been challenging for traditional RL to learn, especially given the relatively data hungry process of exploration and temporal credit assignment required for RL. This has been especially limiting in real-world or real-world-like embodied tasks that operate over motor-control action spaces that make even relatively simple tasks require a long series of motor actions.

In particular, RL has primarily thrived in worlds that accommodate simple abstract action spaces like games, where a single ‘action’ elicits large changes in the environment. However, this is limiting. For example, a central advantage of generic embodied action spaces is that they are realistic, flexible, and permit open-ended and emergent behaviors. RL's inability to operate over these action spaces (due to challenges in exploration and long-term credit assignment over long action sequences) has been a major impediment to its application in real-world settings.

Hierarchical reinforcement learning (RL), i.e., techniques that control an agent using a low-level controller and a high-level controller, has been a compelling approach for achieving goal directed behavior over long sequences of actions and addressing the above issues with “flat” reinforcement learning approaches. Intuitively, this means that the ‘action space’ that one actually does credit assignment and exploration over are temporally extended sequences of actions that achieve subgoals on the path toward achieving the target task. The main challenge here has been to devise (or learn) a general enough space of subgoals that both effectively reduces the planning horizon but is also expressive enough to permit interesting behaviors. In particular, a core challenge is to find the right set of abstractions for a given domain and set of tasks. For example, many existing approaches represent sub-goals that are generated as output by the high-level controller (to be provided as input to the low-level controller) as latent vectors of numerical values. However, the resulting vectors are not interpretable and learning sub-goals that effectively reduce the planning horizon becomes difficult.

This specification instead describes using natural language as a way to parameterize this subgoal space. Language is a lossy channel—a text description of an agent trajectory will discard a lot of (detailed, grounded, visual) information. However, language has evolved explicitly to still be expressive enough to represent the vast majority of ideas, goals, and behaviors relevant to humans. This makes it a strong contender for specifying subgoals that both effectively reduce complexity, while retaining expressivity where it matters. Language also has the added advantage that training data can be readily acquired, e.g., from human users or other agents. In particular, this specification describes how to train a high-level controller to effectively generate natural language commands that can be processed by a low-level controller to control the agent. In particular, this specification describes how the system can use data that includes natural language commands for an agent to softly supervise a hierarchical agent that can learn to solve complex long-horizon tasks, e.g., in a 3-D embodied environment. That is, by making use of the described training techniques, the system can train the high-level controller to effectively communicate with the low-level controller through natural language.

Additionally, using unconstrained natural language to parameterize the subgoal space has additional advantages. For example, it is easy to generate demonstration data, e.g., from human participants. As another example, it is flexible enough to represent a vast range of sub-goals in human-relevant tasks. As yet another example, natural language commands are interpretable by users, e.g., those that are monitoring the performance of the agent.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 is a flow diagram of an example process for controlling an agent at a given time step.

FIG. 3 is a flow diagram of an example process for training the high-level controller neural network.

FIG. 4 shows an example of the operation of the system.

FIG. 5 shows examples of the performance of an example of the described techniques.

Like reference numbers and designations in the various drawings indicate like elements.

### DETAILED DESCRIPTION

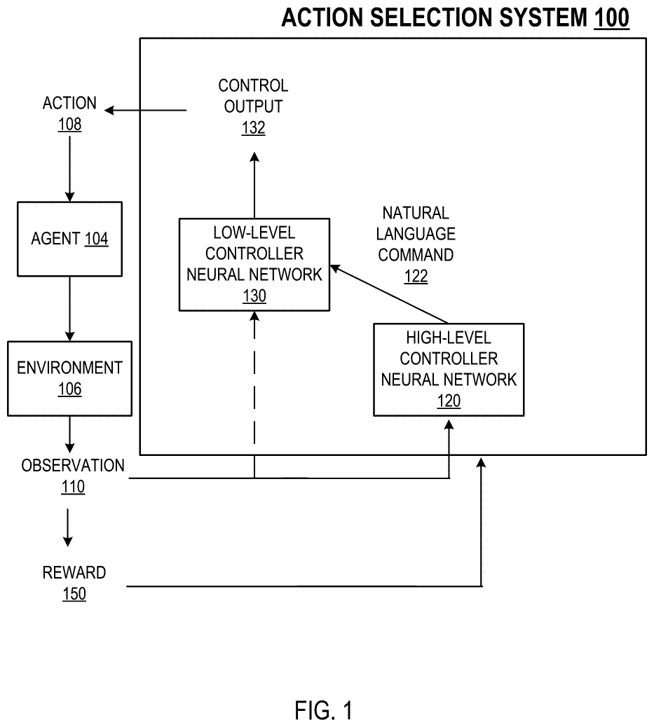

FIG. 1 shows an example action selection system 100. The action selection system 100 is an example of a system implemented as computer programs on one or more computers in one or more locations in which the systems, components, and techniques described below are implemented.

The action selection system 100 uses a high-level controller neural network 120 and a low-level controller neural network 130 to control an agent 104 interacting with an environment 106 to perform a task in the environment 106. For example, the agent 104 can be a robot, e.g., a robotic arm, a quadruped robot, a humanoid robot, or other type of robot that is controllable by the system 100. The agent 104 can also be a different type of agent, e.g., a control system for a facility, a software agent, and so on. As a particular example, the agent 104 can be an avatar or other character in a video game environment. For example, one or more other agents within the video game environment can be controlled by users, while the agent 104 is controlled by the system 100.

Examples of agents, environments, and tasks will be described below.

When controlling the agent 104, the system 100 controls the agent 104 to accomplish a task by selecting actions 108 to be performed by the agent 104 at each of multiple time steps during the performance of an episode of the task.

An “episode” of a task is a sequence of interactions during which the agent attempts to perform an instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 100 receives an observation 110 characterizing the current state of the environment 106 at the time step and, in response, selects an action 108 to be performed by the agent 104 at the time step. After the agent 104 performs the action 108, the environment 106 transitions into a new state.

The observation 110 can include any appropriate information that characterizes the state of the environment. As one example, the observation 110 can include sensor readings from one or more sensors configured to sense the environment. For example, the observation 110 can include one or more images captured by one or more cameras, measurements from one or more proprioceptive sensors, and so on.

In some cases, the system 100 receives an extrinsic reward 150 (also referred to as a “task” reward) from the environment in response to the agent performing the action.

Generally, the reward is a scalar numerical value and characterizes a progress of the agent towards completing the task.

As a particular example, the reward can be a sparse binary reward that is zero unless the task is successfully completed and one if the task is successfully completed as a result of the action performed.

As another particular example, the reward can be a dense reward that measures a progress of the agent towards completing the task as of individual observations received during the episode of attempting to perform the task, i.e., so that non-zero rewards can be and frequently are received before the task is successfully completed.

In some cases, the reward can be generated by a reward model, such as based on the observation 110. As one example of this, the reward model may be learned using a success detector that detects successful behavior from observations of the environment, e.g., as described in “Vision-Language Models as Success Detectors” arXiv:2303.07280.

Generally, when controlling the agent 104, the system 100 uses the high-level controller neural network 120 to generate natural language commands 122 while using the low-level controller to generate control outputs 132 for controlling the agent 104.

More specifically, at each time step, the system 100 receives an observation 110 characterizing the state of the environment 106 at the time step.

The system 100 uses the high-level controller neural network 120 to generate a natural language command 122 for the time step based on the observation 110.

In some cases, the system 100 may not generate a new command at every time step. In these cases, at some time steps, the system 100 can use the most recently generated natural language command 122 as the command for the time step while, at other time steps, the system processes the observation 110 to generate a new command for the time step. That is, the system 100 can re-use the most recently received natural language command 122 until a new command 122 is generated by the high-level controller 120.

The “natural language command” 122 is referred to as “natural language” because it is a sequence of text in a natural language, e.g., English, French, or Spanish, that specifies a command that can be followed by the agent. The commands generally specify high-level interactions with the environment rather than low-level inputs for the controls of the agent. Examples of commands include “move forward,” “drop it,” “hold the cube,” and so on. In other words, the natural language commands 122 can specify, in natural language, subgoals to be achieved by the agent as part of performing the task.

Thus, the controller neural network 120 is referred to as a “high” level controller because the controller generates high-level outputs that do not directly specify control inputs for the agent 104 and instead specify “high-level” directions for the agent. The controller neural network 120 can equivalently be referred to as a first controller neural network.

The high-level controller 120 is a neural network that is configured to receive an input that includes an observation characterizing a state of an environment being interacted with by an agent and to generate an output defining a natural language command for a low-level controller neural network that generates control outputs for controlling the agent.

The input to the high-level controller 120 can also optionally include additional data in addition to the observation. For example, the system 100 can receive, e.g., from a user or from the environment, a natural language instruction or other communications specifying the task to be performed. In this example, the input to the high-level controller 120 can also include the most-recent communication. As another example, the input can include one or more previous natural language commands that have been generated at one or more preceding time steps.

The high-level controller 120 can generally have any appropriate architecture that allows the neural network to map an input that includes an observation to a natural language command.

For example, the high-level controller 120 can include an encoder neural network that encodes the input to generate an encoded representation of the input and then additional layers that operate on the encoded representation to generate the command.

For example, the additional layers can include one or more self-attention layers that operate on the encoded representation. Examples of suitable architectures for the self-attention layers are described in Ashish Vaswani et al., “Attention is all you need”, Advances in Neural Information Processing Systems, pp. 5998-6008, 2017; arXiv: 1810.04805 Devlin et al. (BERT); and arXiv: 1901.02860 Dai et al. (Transformer-XL). For example, a self-attention layer may comprise an attention mechanism defined by query (“Q”), key (“key”) and value (“V”) matrices, composed of trained numerical parameters, and be configured to generate an output which is based on a product of an input sequence with the value matrix, weighted by a function of a product of the input sequence with the query matrix and of a product of the input sequence with the key matrix.

As another example, the additional layers can include one or more recurrent neural network layers that operate on the encoded representation.

As a particular example, including recurrent or self-attention layers in the high-level controller 120 can allow the high-level controller 120 to be conditioned on previous observations received at previous time steps.

As a particular example, when the observations are images and the controller also receives natural language instructions, the high-level controller 120 can include an image encoder neural network, e.g., a convolutional neural network or a Transformer neural network that includes one or more self-attention layers, a text encoder neural network, e.g., a recurrent neural network or a Transformer neural network that includes one or more self-attention layers, and a multi-modal neural network combines the outputs of the image and text encoders to generate a combined representation. For example, the multi-modal neural network can be implemented as one or more self-attention layers that apply attention over the outputs of the image and text encoders. When the high-level controller 120 does not receive text, the high-level controller 120 can include only the image encoder and the output of the image encoder can be considered as the combined representation. The high-level controller 120 can then include a recurrent neural network layer, e.g., a long-short term memory (LSTM) layer, that incorporates context from previous observations, and then a text decoder, e.g., a recurrent neural network or a Transformer neural network, that generates the natural language command.

The system 100 then processes an input that includes at least the natural language command 122 for the time step using the low-level controller neural network 130 to generate a control output 132 for controlling the agent 104 at the time step.

The low-level controller neural network 130 is a neural network that is configured to receive an input that includes a natural language command and to process the input to generate a control output 132 for the controlling the agent 104.

The control output 132 specifies inputs for one or more controls of the agent 104. That is, the control output 132 is a “low-level” output that can be directly used to control the agent. For example, when the agent 104 is a robot, the low-level output can include a respective input for each of multiple actuators, joints, or other controllable elements of the robot.

Thus, the controller neural network 130 is referred to as a “low” level controller because the controller generates low-level outputs that directly specify control inputs for the agent 104, e.g., as opposed to specifying “high-level” directions for the agent. The controller neural 130 can equivalently be referred to as a second controller neural network.

The input to the low-level controller neural network 130 can optionally also include other data. For example, the input to the low-level controller 130 can include the observation 110 at the time step. As another example, the input to the low-level controller 130 can include a portion of the observation 110 at the time step. For example, when the observation 110 includes data from multiple different sensors, the input to the low-level controller 130 can include the data from a proper subset of the sensors, e.g., from only proprioceptive sensors and not from sensors that generate higher-dimensional outputs, e.g., image or lidar sensors.

As another example, the input to the low-level controller neural network 130 can include the instruction or other communication received from the environment or from a user.

The low-level controller neural network 130 can generally have any architecture that allows the neural network 130 to map the input to the control output 132. For example, the low-level controller neural network 130 can include an encoder neural network to encode the input and one or more additional layers to generate the control output 312 from the encoded input. For example, the low-level controller neural network 130 can share an encoder with the high-level controller 120.

As a particular example, the low-level controller neural network 130 can have the same architecture as the example architecture given above for the high-level controller 120, but with the text decoder replaced by a decoder that generate the control output, e.g., a multi-layer perceptron (MLP), an RNN, or a Transformer neural network.

In order for the high-level controller 120 to generate commands 122 that the low-level controller 130 can use to accurately perform tasks in the environment 106, the system 100 trains the high-level controller 120.

In some implementations, the system 100 trains the high-level controller 120 through supervised learning on a set of demonstration trajectories. Each demonstration trajectory in turn includes, for each of a plurality of time steps, a respective observation characterizing a state of a demonstration environment being interacted with by a demonstration agent (e.g., an agent of the same form as the agent 104) at the time step and a respective natural language command provided to the demonstration agent at the time step.

In some other implementations, the system 100 trains the high-level controller 120 through reinforcement learning, e.g., by iteratively modifying the high-level controller to maximize a function of the rewards 150, e.g., an expectation value of a return function of the rewards at multiple time steps of an episode. When training using reinforcement learning, the system 100 controls the agent using the high-level controller 120 and uses the resulting rewards to train the high-level controller 120.

In yet other implementations, the system 100 trains the high-level controller 120 through both supervised learning and reinforcement learning.

When training using both supervised learning and reinforcement learning, the system 100 can first train the high-level controller 120 through supervised learning and then through reinforcement learning. Alternatively, the system 100 can train the high-level controller 120 jointly through both supervised learning and reinforcement learning, e.g., on an overall loss function that is a sum or a weighted sum of the supervised learning loss and the reinforcement loss. That is, each training step can include updating the parameters of the controller using gradients of both losses.

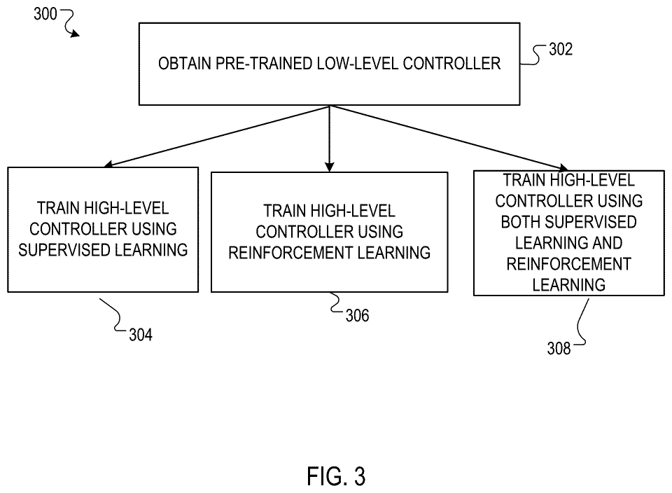

Generally, whether training with supervised learning or reinforcement learning, the system 100 or another training system first pre-trains the low-level controller 130 and then the system 100 holds the low-level controller 130 fixed during the training of the high-level controller 120. For example, the system 100 or the other training system can train the low-level controller 130 through supervised learning, e.g., through imitation learning. An example of this is described below with reference to FIG. 3. As another example, the system 100 or the other training system 100 can train the low-level controller 120 through reinforcement learning with a different high-level controller, i.e., by controlling the agent using the low-level controller 120 conditioned on commands generated by a different high-level controller, e.g., an already-trained neural network or a fixed policy that maps time steps in trajectories to commands.

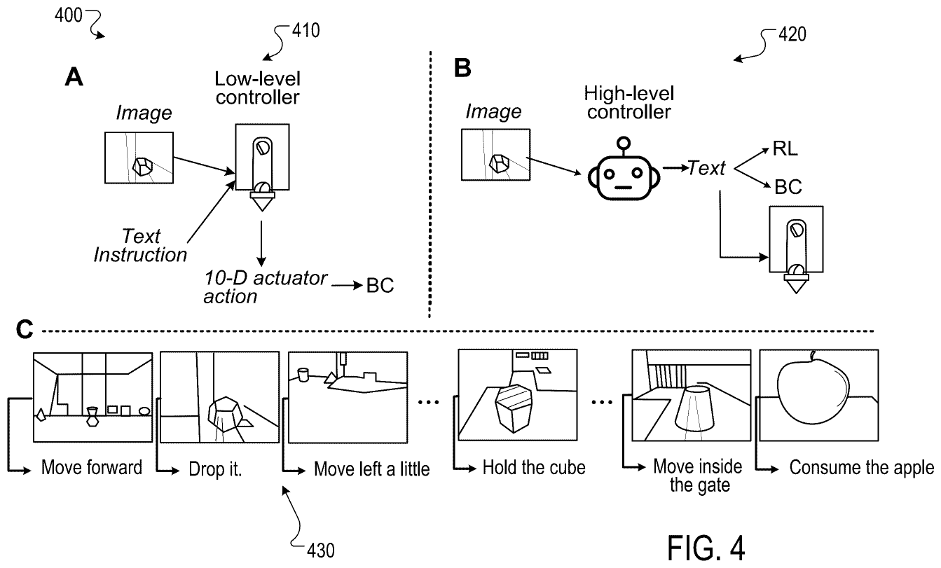

Training the high-level controller 120 and the low-level controller 130 is described in more detail below with reference to FIGS. 3 and 4.

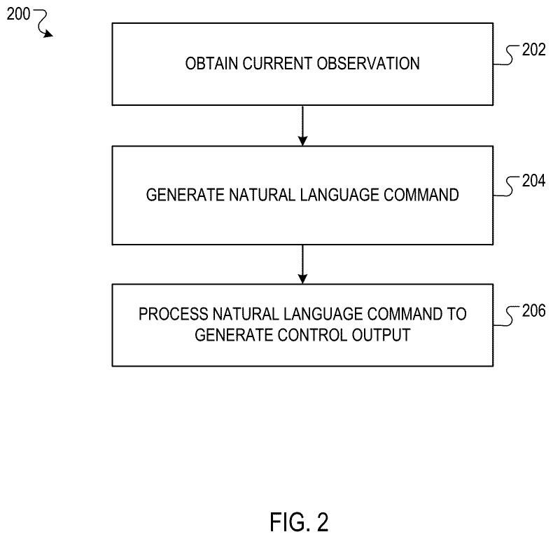

FIG. 2 is a flow diagram of an example process 200 for controlling the agent at a given time step during a task episode. For convenience, the process 200 will be described as being performed by a system of one or more computers located in one or more locations. For example, an action selection system, e.g., the action selection system 100 of FIG. 1, appropriately programmed in accordance with this specification, can perform the process 200.

The system receives an observation characterizing the state of the environment at the time step (step 202).

The system uses the high-level controller neural network to generate a natural language command for the time step (step 204).

As described above, the “natural language command” is referred to as “natural language” because it is a sequence of text in a natural language, e.g., English, French, or Spanish, that specifies a command that can be followed by the agent. In other words, the natural language commands can specify, in natural language, subgoals to be achieved by the agent as part of performing the task.

In some cases, the system may not generate a new command at every time step. In these cases, at some time steps, the system can use the most recently generated natural language command as the command for the time step. That is, the system can re-use the most recently received natural language command until a new command is generated.

In particular, when one or more criteria are satisfied for generating a new command the system can process an input that includes the observation at the time step using the high-level controller neural network to generate the natural language command for the time step.

The system can determine whether the criteria are satisfied in any of a variety of ways. As one example, the system can determine that the criteria are satisfied every k time steps, where k is an integer that is greater than one. As another example, the system can use a learned model or heuristics to determine, from the observation or from other data available from the environment, whether the previous natural language command has successfully been executed by the agent and, if so, determine that the criteria are satisfied.

The system then processes at least the natural language command using the low-level controller neural network to generate a control output for controlling the agent at the time step (step 206).

As described above, the control output is a “low-level” output that can be directly used to control the agent. For example, when the agent is a robot, the low-level output can include a respective input for each of multiple actuators, joints, or other controllable elements of the robot.

FIG. 3 is a flow diagram of an example process 300 for training the high-level controller neural network. For convenience, the process 300 will be described as being performed by a system of one or more computers located in one or more locations. For example, an action selection system, e.g., the action selection system 100 of FIG. 1, appropriately programmed in accordance with this specification, can perform the process 300.

The system obtains data specifying a pre-trained low-level controller neural network (step 302).

That is, the system or another training system pre-trains the low-level controller neural network prior to the training of the high-level controller neural network.

In particular, the low-level controller neural network can have been pre-trained through supervised learning on a plurality of low-level demonstration trajectories.

Each low-level demonstration trajectory includes, for each of a plurality of time steps, a (i) respective observation characterizing a state of a demonstration environment being interacted with by a demonstration agent at the time step, (ii) a respective natural language command provided to the demonstration agent at the time step, (iii) and an action performed by the demonstration agent at the time step. The action performed by the agent is a low-level action in the same space as the control outputs generated by the low-level controller.

For example, the system can obtain these low-level trajectories by logging the interactions of the demonstration agent with the demonstration environment.

For example, the demonstration agent can be, e.g., an agent being controlled by a fixed already-learned policy, an agent being controlled by a user, or a human user that is performing tasks in the environment. In particular, at each time step, the demonstration agent or the user controlling the demonstration agent can be provided the respective natural language command and then the demonstration agent can perform the action at the time step.

As a particular example, the system can collect the low-level trajectories based on interactions with the demonstration environment of a ‘setter’ agent and a ‘Solver’ agent to perform a set of tasks. For the given tasks, a single controllable agent is controlled by the ‘Solver’. Given the task goal, the ‘Setter’ instructs the ‘Solver’, e.g., a chat interface, on how to solve the task. The ‘Setter’ can observe the ‘Solver’ but cannot interact with the environment directly. For example, the ‘Setter’ and the ‘Solver’ and solver can both be controlled by users or the ‘Setter’ can be controlled by a user while the ‘Solver’ is controlled by a natural language conditioned policy that receives natural language inputs and outputs control outputs.

As one example, the low-level controller can be trained on the low-level demonstration trajectories through behavior cloning. When training through behavior cloning, the system cant rain the low-level controller to minimize a behavior cloning loss that measures, for each of the plurality of time steps in each low-level demonstration trajectory, a probability assigned to the respective demonstration action performed by the demonstration agent at the time step by an output generated by the low-level controller neural network by processing an input comprising the respective command for the time step. For example, when the low-level controller also receives as input the observations o, the supervised training objective can be:

$${BC}_{LL}^{} = - \frac{1}{B} {\sum }_{n = 1}^{B} {\sum }_{t = 0}^{K} ln π ( {a}_{n , t} \vert {o}_{n , \leq t} , {g}_{n , t} ) ,$$

where π denotes the low-level controller, g is a natural language command, a is the demonstration action, B is a number of trajectories in a batch (labelled by an integer index n), and K is a number of time steps in a trajectory (labelled by an integer index t).

The system then trains the high-level controller neural network.

As one example, the system can train the high-level controller neural network through supervised learning (step 304).

Training through supervised learning generally includes obtaining a training data set that includes a plurality of demonstration trajectories.

Each demonstration trajectory in turn includes, for each of a plurality of time steps, a respective observation characterizing a state of the demonstration environment being interacted with by the demonstration agent at the time step and a respective natural language command provided to the demonstration agent at the time step.

For example, the demonstration trajectories can be generated from the same interactions as the low-level demonstration trajectories or from a different set of demonstration data.

The system then trains the high-level controller neural network on the demonstration trajectories in the training data set through supervised learning, e.g., through behavior cloning.

For example, when using behavior cloning, the system can train on a loss that measures, for each of the plurality of time steps in each demonstration trajectory, a probability assigned to the respective natural language command provided to the demonstration agent at the time step by an output generated by the high-level controller neural network by processing an input comprising the respective observation for the time step. For example, the objective can satisfy:

$${BC}_{HL}^{} = - \frac{1}{B} {\sum }_{n = 1}^{B} {\sum }_{t = 0}^{K} ln π ( {g}_{n , t} \vert {o}_{n , \leq t} )$$

where π denotes the high-level controller neural network and B, n, K, t, g, and o are defined as above.

As another example, the system can train the high-level controller neural network through reinforcement learning (step 304).

Training the high-level controller generally includes generating a reinforcement learning trajectory by, at each of a plurality of first time steps in the reinforcement learning trajectory, performing the process 200 to control the agent. A “first” time step is one at which the criteria for generating a new natural language command are satisfied.

That is, at each “first” time step at which the criteria as satisfied, the system can perform the following: receiving a current observation characterizing a state of a training environment being interacted with by a training agent; processing an input comprising the current observation using the high-level controller neural network to generate an output defining a natural language command for the first time step; processing an input comprising the natural language command for the first time step using the low-level controller neural network to generate a control output for the first time step; and controlling the agent using the control output.

The system then receives a reward for the first time step. Thus, the trajectory generally includes, for each first time step, the observation, the natural language command, and the reward.

The system then trains the high-level controller neural network through reinforcement learning using at least the rewards for the first time steps. That is, although the rewards were generated as a result of control outputs produced by the low-level controller neural network, the system associates the rewards with the corresponding natural language commands generated by the high-level controller neural network.

In some cases, the system also trains the high-level controller neural network on rewards for the “second” time steps at which the criteria are not satisfied and the most-recent natural language command is re-used. That is, the trajectories include both the “first” and the “second” time steps. In these cases, at each of the second time steps in the reinforcement learning trajectory, the system receives a current observation characterizing a state of the training environment being interacted with by the training agent; determines that the criteria are not satisfied for generating a new natural language command; and in response, processes an input that includes the natural language command from a most recent first time step using the low-level controller neural network to generate a control output for the second time step; and controls the training agent using the control output. The system then receives a reward for the second time step. Thus, the trajectory generally includes, for each second time step, the observation, the most recent natural language command, and the reward.

The system can generally train the high-level control on any appropriate reinforcement learning objective that trains the neural network to maximize expected returns. Examples of such objectives include policy gradient algorithms, actor critic algorithms, and so on.

As a particular example, when the system uses the V-Trace objective, the system augments the neural network with a value head and optimizes:

$${RL}_{HL}^{} = \frac{1}{B} {\sum }_{n = 1}^{B} {\sum }_{t = 0}^{K} {R}_{n , t} - {V}_{n , t} ln π ( {g}_{n , t} \vert {o}_{n , \leq t} ) ,$$

where R_{n,t} is the return received by the agent subsequent to the environment being in the state characterized by the observation at time step t in trajectory n and V_{n,t} is the value score generated by the value head at time step t in trajectory n. The value score generally measures an estimated return that will be received by the agent subsequent to the environment being in the state characterized by the observation at time step t. The return measures a combination, e.g., a sum or a time-discounted sum, of the rewards received at future time steps in the trajectory n.

Since the low-level controller is frozen during the reinforcement learning training, the high and low level controllers cannot develop a different communication protocol via RL—the high-level controller is restricted to using commands that the low-level controller trained on natural language instructions can understand. This adds interpretability to the agent's behavior after training.

As yet another example the system can train the high-level controller neural network through both reinforcement learning and supervised learning (step 308).

When training using both supervised learning and reinforcement learning, the system can first train the high-level controller through supervised learning and then through reinforcement learning.

Alternatively, the system can train the high-level controller jointly through both supervised learning and reinforcement learning, e.g., on an overall loss function that is a sum or a weighted sum of the supervised learning loss and the reinforcement loss. That is, each training step can include updating the parameters of the controller using gradients of both losses.

For example, the overall loss function can satisfy:

$${HL}^{} = {w}_{BC} {BC}_{HL}^{} + {w}_{RL} {RL}_{HL}^{}$$

where w_{BC} is the weight assigned to the supervised learning objective and w_{RZ} is the weight assigned to the reinforcement learning objective.

FIG. 4 shows an example 400 of the operation of the system.

In the example 400, the high-level and low-level controllers each receive an input that includes an observation image of the environment. In the example 400, the images are first-person images captured by a camera of a robot.

In particular, FIG. 4 shows an example 410 of the observations, outputs, and losses for the low-level controller 130. As shown in the example 410, the low-level controller receives an input that includes an image and a text instruction and processes the input to generate a control output that includes a 10-dimensional action vector, e.g., that includes a respective control input for each of a set of actuators of the robot. During training of the low-level controller, the control output is used to compute a behavior cloning (BC) loss that measures the difference between the control output and an output that specifies an action performed by a demonstration agent given the observation and the text instruction.

FIG. 4 also shows an example 420 of the observations, outputs, and losses for the high-level controller 120. As shown in the example 420, the high-level controller receives an input that includes an image and processes the input to generate a natural language text command. During training of the high-level controller, the command is used to compute a behavior cloning (BC) loss and a reinforcement learning (RL) loss.

FIG. 4 also shows an example 430 of observation inputs provided as input to the high-level controller 120 and corresponding natural language commands generated as output by the high-level controller 120 during an episode of a task that requires controlling a robot to find and consume an apple. As can be seen from the example, the commands change drastically throughout the episode based on the context provided by the observation images.

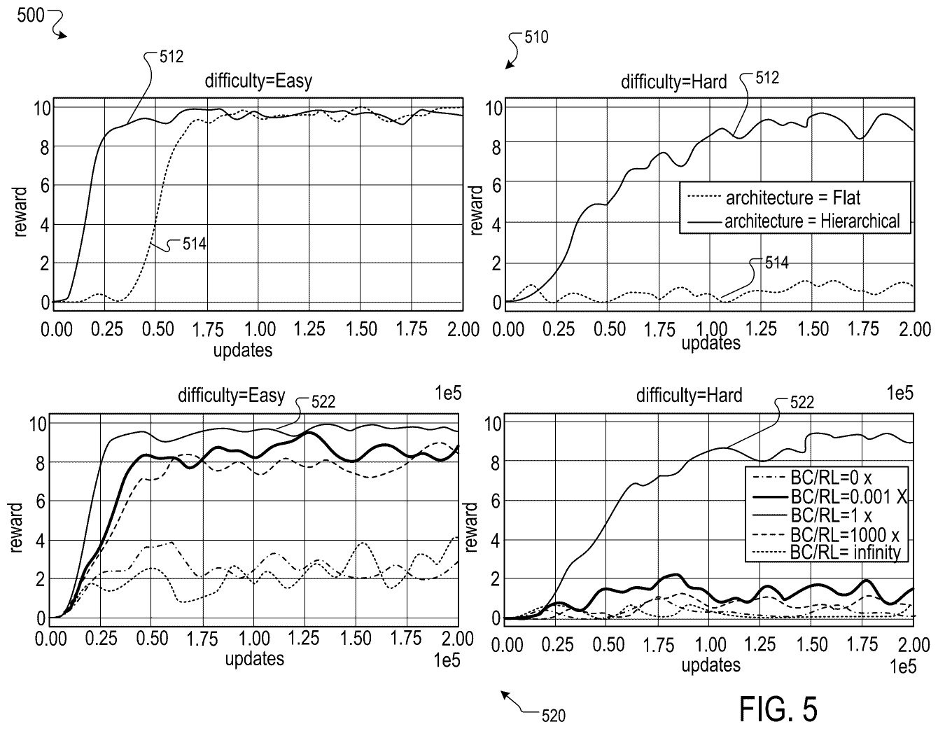

FIG. 5 shows examples of the performance of an example of the described techniques.

In particular, FIG. 5 shows an example 510 of the performance of the described techniques (“hierarchical”) 512 relative to a technique that controls the agent using a “flat” architecture 514 that uses a single neural network to directly map observations to control outputs. As can be seen from the example 510, while the flat architecture 514 can control the agent to perform easy tasks, the described techniques 512 significantly outperform the flat architecture 514 on hard tasks. Thus, the results show that the described hierarchy allows the system to successfully cause the agent to achieve longer and more complex tasks than would be possible without it.

FIG. 5 also shows an example 520 of the performance of various examples of the described techniques. More specifically, the example 520 shows the performance with various ratios of behavior cloning (BC) to reinforcement learning (RL) training. For example, these ratios can represent different ratios of w_{BC} to w_{RL} in the overall loss function. As can be seen from the example 520, using both behavior cloning and RL training generally outperforms using only BC or RL, particularly for hard tasks. For example, the example 520 shows the performance 522 of an equal ratio (BC/RL=1) exceeding the performance of ratios that indicate that only one of BC or RL is used (BC/RL=0× or BC/RL=infinity) and ratios that indicate one of BC or RL is strongly favored over the other (0.0001× or 1000×).

As described above, the system can use various environments to train and control the high and low-level controller neural networks. For example, the system can use data collected from a demonstration environment to train the neural network(s) through supervised learning. As another example, the system can control the agent in a training environment as part of training through reinforcement learning. As yet another example, the system can control the agent in an “inference” environment after training.

These environments can all be the same environment or can be different environments.

For example, the demonstration environment can be the same as the inference environment or can be a different environment. As a particular example, the demonstration environment can be a simulated environment and the inference environment can be the simulated environment or can be a real-world environment that is being simulated by the demonstration environment.

As another example, the training environment can be the same as the inference environment or can be a different environment. As a particular example, the training environment can be the simulated environment and the inference environment can be the simulated environment or can be a real-world environment that is being simulated by the training environment.

Some examples of the types of agents the system can control now follow.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example, in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent (typically an electromechanical agent). The control signals may also or instead include electronic control data such as motor control data, or more generally data for controlling one or more electronic devices within the environment the control of which has an effect on the observed state of the environment. For example, in the case of an autonomous or semi-autonomous land or air or sea vehicle the control signals may define actions to control navigation, e.g., steering, and movement, e.g., braking and/or acceleration of the vehicle.

In some implementations the environment is a simulation of the above-described real-world environment, and the agent is implemented as one or more computers interacting with the simulated environment. For example, the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example, the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general, the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example, in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example, a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general, the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example, a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example, in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example, in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example, a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound and the agent is a computer system for determining elements of the pharmaceutically active compound and/or a synthetic pathway for the pharmaceutically active compound. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources, e.g., on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example, rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus, a design an entity may be optimized, e.g., by reinforcement learning, and then the optimized design output for manufacturing the entity, e.g., as computer executable instructions; an entity with the optimized design may then be manufactured.

As previously described the environment may be a simulated environment. Generally, in the case of a simulated environment the observations may include simulated versions of one or more of the previously described observations or types of observations and the actions may include simulated versions of one or more of the previously described actions or types of actions. For example, the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally, the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example, the system may be partly trained using a simulation of a mechanical agent in a simulation of a particular real-world environment, and afterwards deployed to control the real mechanical agent in the particular real-world environment. Thus, in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

Aspects of the present disclosure may be as set out in the following clauses:

1. A method performed by one or more computers and for training a high-level controller neural network that is configured to receive an input comprising an observation characterizing a state of an environment being interacted with by an agent and to generate an output defining a natural language command for a low-level controller neural network that generates control outputs for controlling the agent, the method comprising:
obtaining a training data set, the training data set comprising:
a plurality of demonstration trajectories, each demonstration trajectory comprising, for each of a plurality of time steps, a respective observation characterizing a state of a demonstration environment being interacted with by a demonstration agent at the time step and a respective natural language command provided to the demonstration agent at the time step; and
training the high-level controller neural network on the demonstration trajectories in the training data set through supervised learning.

2. The method of claim 1, wherein training the high-level controller neural network on the demonstration trajectories in the training data set through supervised learning comprises:
training the high-level controller neural network on the demonstration trajectories in the training data set to minimize a behavior cloning loss that measures, for each of the plurality of time steps in each demonstration trajectory, a probability assigned to the respective natural language command provided to the demonstration agent at the time step by an output generated by the high-level controller neural network by processing an input comprising the respective observation for the time step.

3. The method of claim 1, wherein the training further comprises:
generating a reinforcement learning trajectory, the generating comprising:
at each of a plurality of first time steps in the reinforcement learning trajectory:
receiving a current observation characterizing a state of a training environment being interacted with by a training agent;
processing an input comprising the current observation using the high-level controller neural network to generate an output defining a natural language command for the first time step;
processing an input comprising the natural language command for the first time step using the low-level controller neural network to generate a control output for the first time step;
controlling the training agent using the control output; and
receiving a reward for the first time step; and
training the high-level controller neural network through reinforcement learning using at least the rewards for the first time steps.

4. The method of claim 3, wherein the input to the low-level controller neural network further comprises the current observation at the first time step.

5. The method of claim 3, the generating comprising:
at each of a plurality of second time steps in the reinforcement learning trajectory:
receiving a current observation characterizing a state of the training environment being interacted with by the training agent;
determining that criteria are not satisfied for generating a new natural language command; and
in response:
processing an input comprising the natural language command from a most recent first time step using the low-level controller neural network to generate a control output for the second time step;
controlling the training agent using the control output; and
receiving a reward for the second time step.

6. The method of claim 5, wherein training the high-level controller neural network through reinforcement learning comprises:
training the high-level controller neural network through reinforcement learning using at least the rewards for the first and second time steps.

7. The method of claim 1, wherein the low-level controller neural network has been pre-trained prior to the training of the high-level controller neural network and is held fixed during the training of the high-level controller neural network.

8. The method of claim 7, wherein the low-level controller neural network has been pre-trained through supervised learning on a plurality of low-level demonstration trajectories, each low-level demonstration trajectory comprising, for each of a plurality of time steps, a respective observation characterizing a state of the demonstration environment being interacted with by the demonstration agent at the time step, a respective natural language command provided to the demonstration agent at the time step, and an action performed by the demonstration agent at the time step.

9. The method of claim 8, wherein the low-level controller has been pre-trained through behavior cloning on the plurality of low-level demonstration trajectories.

10. The method of claim 1, wherein, at each time step, the high-level controller neural network is conditioned on observations at one or more previous time steps.

11. The method of claim 10, wherein the high-level controller neural network comprises one or more recurrent layers.

12. The method of claim 10, wherein the high-level controller neural network comprises one or more self-attention layers.

13. The method of claim 1, wherein the environment is a simulated environment or a real-world environment.

14. The method of claim 13, wherein the environment is a real-world environment, and the observations are obtained from one or more sensors which sense the real-world environment.

15. The method of claim 14, wherein the agent is a mechanical robot interacting with the real-world environment.

16. The method of claim 1, wherein the demonstration environment is the same as the environment.

17. The method of claim 1, wherein the demonstration environment is different from the environment.

18. The method of claim 1, wherein the environment is a video game environment and the agent is an agent in the video game environment.

19. A system comprising one or more computers and one or more storage devices storing instructions that when executed by the one or more computers cause the one or more computers to perform operations for training a high-level controller neural network that is configured to receive an input comprising an observation characterizing a state of an environment being interacted with by an agent and to generate an output defining a natural language command for a low-level controller neural network that generates control outputs for controlling the agent, the operations comprising:
obtaining a training data set, the training data set comprising:
a plurality of demonstration trajectories, each demonstration trajectory comprising, for each of a plurality of time steps, a respective observation characterizing a state of a demonstration environment being interacted with by a demonstration agent at the time step and a respective natural language command provided to the demonstration agent at the time step; and
training the high-level controller neural network on the demonstration trajectories in the training data set through supervised learning.

20. One or more non-transitory computer-readable media storing instructions that when executed by one or more computers cause the one or more computers to perform operations for training a high-level controller neural network that is configured to receive an input comprising an observation characterizing a state of an environment being interacted with by an agent and to generate an output defining a natural language command for a low-level controller neural network that generates control outputs for controlling the agent, the operations comprising:
obtaining a training data set, the training data set comprising:
a plurality of demonstration trajectories, each demonstration trajectory comprising, for each of a plurality of time steps, a respective observation characterizing a state of a demonstration environment being interacted with by a demonstration agent at the time step and a respective natural language command provided to the demonstration agent at the time step; and
training the high-level controller neural network on the demonstration trajectories in the training data set through supervised learning.
